(19) United States
(12) Patent Application Publication
(10) Pub. No.: US 2004/0125436 A1
(43) Pub. Date: Jul. 1, 2004

(54) Modulated tunneling stream (MTS) transceiver

(76) Inventor: David Robert Morgan, Conroe, TX (US)

Correspondence Address: David Robert Morgan, 202 Montrose Circle, Conroe, TX, 77301, US

(21) Appl. No.: 10/330,664

(22) Filed: Dec. 30, 2002

(51) Int. Cl. G02F 1/09; H01S 3/00

(52) U.S. Cl. 359/342; 359/280

(57) ABSTRACT

This invention pertains to an improvement on radio transceiver technology. It presents a new method for transmitting and receiving a radio signal. The claims listed within are all limited to the application of the technology for the transmitting and receiving of data. The technology exists as a replacement to the standard antenna. There are subtle variations from existing technologies as well as possible unique applications of the technology being patented. None of the claims are known to be in the public domain, but the distinctions may require legal expertise.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The prior art is the use of electromagnetic waves, in the range of the electromagnetic spectrum known to interact with non-tunneling matter, generated by a stream of amplitude modulated, or frequency modulated, charged particles that induce an accompanying stream of charged particles for the purpose of transmission of data. The prior art does not include modulating the flow of a stream of charged particles while they are tunneling. The prior art for causing particles to tunnel involves colliding accelerated particles into a barrier, or by using adjacent materials of a suitable type and temperature to create a Josephson junction effect. The prior art for transmitting data with tunneling electrons or photons does not involve an intended acceleration of charged particles while they are tunneling but rather it involves solely the use of the flow of particles as the signal itself, or the modulation of a flow of charged particles to generate photons that are then caused to tunnel. Prior art is also limited to detecting such transmissions with non-tunneling charged particles.

### BRIEF SUMMARY OF THE INVENTION

This patent applies to the use of the regions of the electromagnetic spectrum that are not likely (with a probability of less than 0.0005) to interact with non-tunneling matter for the use of data transmission. This patent applies to the use of electromagnetic waves generated by a stream of amplitude modulated, or frequency modulated, tunneling charged particles that are received by an accompanying stream of tunneling charged particles for the purpose of transmission of data. This patent also applies to the specific methods introduced for causing the charged particles to tunnel.

### BRIEF DESCRIPTION OF THE SEVERAL VIEWS OF THE DRAWING

FIG. 1: Arrangement of components of the device.

FIG. 2: Sample energy hill and well as would be present in the device.

FIG. 3: Two imaginary two-dimensional surfaces, one with a magnetic field aligned along its perimeter another with a set of magnetic fields aligned along its perimeter.

FIG. 4: A set of magnetic fields, aligned along the perimeter of an imaginary two-dimensional surface, with increasing field strength that forces a charged particle along the normal of the surface.

### DETAILED DESCRIPTION OF THE INVENTION

The invention is described as a combination of the following in no particular time sequence:

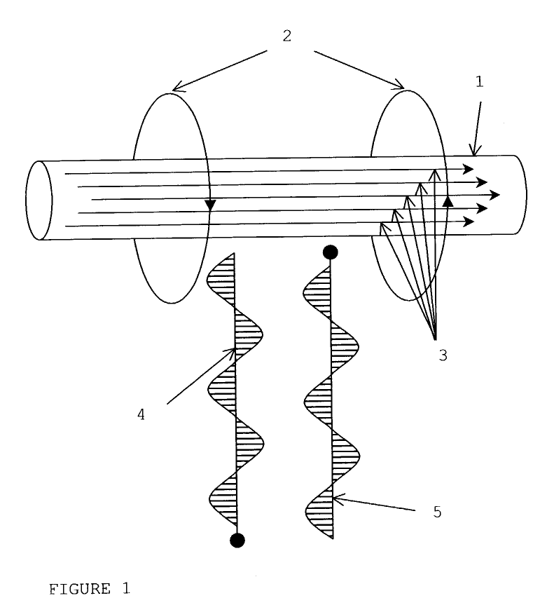

a.) A stream of charged particles flows through a vacuum or dielectric (FIG. 1-1). These particles (FIG. 1-3) will be of either a negative or a positive charge. This charge will be hence referred to in this description as the chosen charge.

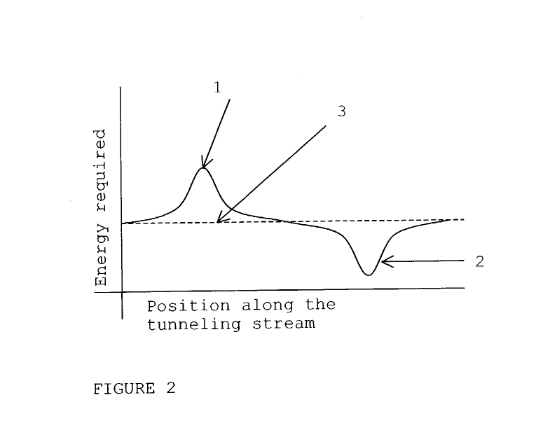

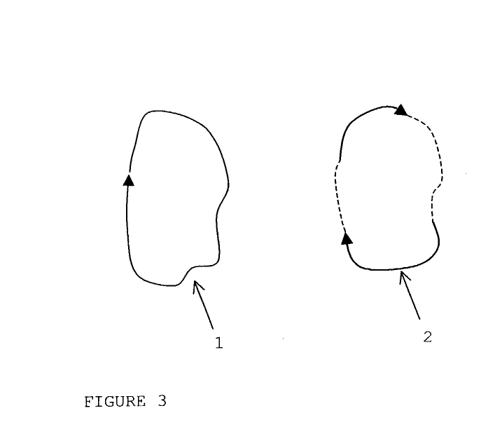

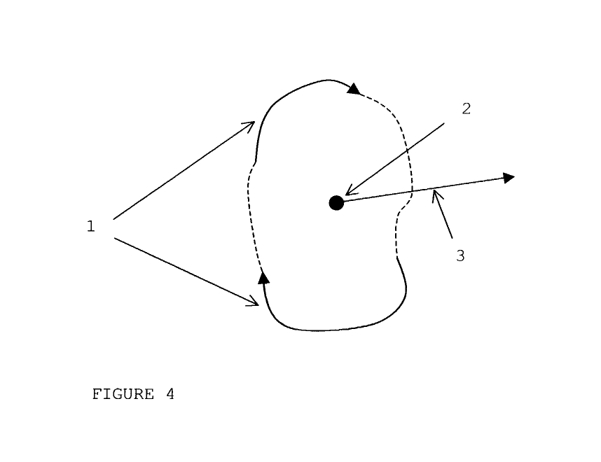

b.) A magnetic field (FIG. 3-1) or a set of magnetic fields (FIG. 3-2) is generated with magnetic field lines aligned along the perimeter (FIG. 4-1) of a finite imaginary two-dimensional surface such that charged particles (FIG. 4-2) inside of the surface perimeter are propelled along the surface normal vector (FIG. 4-3) as the magnetic field strength increases. The ideal surface would be a circle.

c.) A second magnetic field that meets the requirements described in part (b) is generated and is aligned such that the chosen charge is forced away from the region between them in opposing directions by each magnetic field or set of magnetic fields as the flux in each increases. The ideal region would be a cylinder. (FIG. 1-2)

d.) Arrange the flow of the charged particles (FIG. 1-3) so that it intersects the two imaginary surfaces of the two fields or sets of fields referred to in parts (b) and (c) along their surface normal.

e.) Optionally, the flux of the magnetic fields is varied over time to match a change in the current of the stream of charged particles. This is done to ensure a consistent energy in the charged particles while they are tunneling.

f.) Create two such devices as outlined above in parts (a) through (e) such that the streams are tunneling to approximately the same degree. This degree of tunneling is determined by the ratio of the mass of the individual particle to the energy required for it to cross the tunneling region in a non-tunneling state. (Charged particles that are not tunneling to approximately the same degree will not be likely to interact electromagnetically.)

g.) Modulate the flow of charged particles (FIG. 1-3) in one device to emit electromagnetic energy (FIG. 1-4) from said particles while they are tunneling, and detect electromagnetic energy (FIG. 1-5) in a companion device by detecting variations in the flow of charged particles (FIG. 1-3) that occur while they are in a tunneling state. The variations will then provide a signal that can be demodulated. The modulation and demodulation is done according to the known methods of modem and radio transceiver technology.

This is an improvement upon existing radio transceiver technology by extending the capabilities of the antenna.

The basic principle of this device is that a stream of charged particles is directed through a magnetic region that resists the flow of the particles and on the other side through a magnetic region that induces the same flow. This creates an energy hill (FIG. 2-1) and well (FIG. 2-2) that can be crossed by charged particles that are tunneling. (FIG. 2-3)

What I claim is my invention is:

1.) Generating electromagnetic waves, in the regions of the electromagnetic spectrum from which the electromagnetic waves are not likely (probability <0.0005) to interact with non-tunneling charged particles, by modulating the flow of a stream of charged particles so that they emit electromagnetic energy while they are tunneling, for the purposes of data transmission and reception.

2.) Detecting electromagnetic energy in said regions, which has been generated in the aforementioned fashion, by detecting variation in the flow of charged particles that are tunneling, for the purposes of data transmission and reception.

3.) The varying of the degree of tunneling, as determined by the ratio of the mass of an individual particle being tunneled to the energy required for an individual particle to cross the energy barrier in a non-tunneling state; of charged particles used in this manner, to distinguish multiple isolated electromagnetic spectrums, for use in the transmission and reception of data.

4.) The use of two magnetic fields, or two sets of magnetic fields each with magnetic field lines aligned along the perimeter of a finite imaginary two-dimensional surface such that charged particles inside of the surface perimeter are propelled along the surface normal vector as the magnetic field increases;
limited by the requirement that the two of these magnetic fields or sets of magnetic fields are aligned along their surface normals such that the flux of each does force particles of either a positive or a negative charge in opposing directions from the force generated upon said particles by the flux of the other magnetic field or set of fields as the field strength of both increases;
limited by the requirement that a stream of charged particles is passed within each imaginary surface's perimeter along the surface normals for the purpose of inducing a tunneling state in the charged particles of the stream;
limited by the requirement that the aforementioned stream is used to absorb and emit electromagnetic energy while in a tunneling state;
and limited to use for the purposes of data transmission and reception.
